(19) United States
(12) Patent Application Publication
(10) Pub. No.: US 2011/0078003 A1
(43) Pub. Date: Mar. 31, 2011

(54) System and Method for Localized Valuations of Media Assets

(76) Inventors: Ryan Steelberg, Irvine, CA (US); Chad Steelberg, Newport Beach, CA (US)

(21) Appl. No.: 12/870,069

(22) Filed: Aug. 27, 2010

Related U.S. Application Data
(63) Continuation-in-part of application No. 12/590,671, filed on Nov. 12, 2009.
Application No. 12/590,671 is a continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007, now Pat. No. 7,809,603.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 61/113,760, filed on Nov. 12, 2008.
(60) Provisional application No. 60/993,096, filed on Sep. 7, 2007.

(51) Int. Cl. G06Q 30/00

(52) U.S. Cl. 705/14.4; 705/1.1

(57) ABSTRACT

An engine, system and method for selecting at least one endorser for use in one or more advertisements. The engine, system and method may include a talent library including a plurality of electronic media assets delineated by respective ones of the at least one endorser, a mention tracker that electronically tracks mentions of the media assets, and that assigns at least one metric to each of the mentions, and a graphical user display that displays the metrics correspondent to a selected one of the at least one endorser based on ones selected from a plurality of geographies, wherein the selected ones of the geographies are a situs of ones of the mentions.

### CROSS-REFERENCE TO RELATED APPLICATIONS

The present application is a continuation-in-part of U.S. patent application Ser. No. 12/590,671, entitled “System and Method For Localized Valuations of Media Assets”, filed Nov. 12, 2009.

U.S. patent application Ser. No. 12/590,671: claims priority to U.S. Provisional Application No. 61/113,760 entitled “System and Method For Localized Valuations of Media Assets,” filed Nov. 12, 2008, and is a continuation-in-part of U.S. patent application Ser. No. 12/144,194, entitled “System and Method For Brand Affinity Content Distribution and Optimization”, filed Jun. 23, 2008, the entire disclosures of which are incorporated by reference herein as if set forth in their entirety.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008.

U.S. patent application Ser. No. 11/981,837 claims priority to U.S. Provisional Application Ser. No. 60/993,096, entitled “System and Method for Rule-Based Generation of Brand Affinity Content,” filed Sep. 7, 2007, and is related to U.S. patent application Ser. No. 11/981,646.

U.S. patent application Ser. No. 12/079,769 is a continuation-in-part of U.S. patent application Ser. No. 12/042,913, entitled “Engine, System and Method for Generation of Brand Affinity Content,” filed Mar. 5, 2008, which is also a continuation-in-part of U.S. patent application Ser. No. 12/072,692.

U.S. patent application Ser. No. 12/072,692 is a continuation-in-part of U.S. patent application Ser. No. 11/981,646.

The disclosures of which are incorporated by reference herein as if each is set forth in its entirety.

### FIELD OF THE INVENTION

The present invention is directed to an advertising engine and, more particularly, to an engine for generation of brand affinity content, and a method of making and using same, and more particularly to a metric system used within such an engine for providing information on assets within the engine.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention provides an engine, system and method for selecting at least one endorser for use in one or more advertisements. The engine, system and method may include a talent library including a plurality of electronic media assets delineated by respective ones of the at least one endorser, a mention tracker that electronically tracks mentions of the media assets, and that assigns at least one metric to each of the mentions, and a graphical user display that displays the metrics correspondent to a selected one of the at least one endorser based on ones selected from a plurality of geographies, wherein the selected ones of the geographies are a situs of ones of the mentions.

Thus, the invention provides an engine, system and method that allows for the obtaining of an endorsement or sponsorship, in the aforementioned high-impact circumstances, either from a specific individual, a specific entity, an affinity brand, a marketing partner, or a sponsor

### BRIEF DESCRIPTION OF THE FIGURES

The present invention will be described herein below in conjunction with the following figures, in which like numerals represent like items, and wherein:

FIG. 1 is a graphical illustration of the endorsed advertising engine of the present invention;

FIG. 2 is a rendering of the operation of an aspect of the present invention;

FIG. 3 illustrates the effect of the present invention with regard to a search advertising model;

FIG. 4 illustrates the effect of the present invention with respect to a display advertising model;

FIG. 5 is a screen shot according to an aspect of the present invention;

FIG. 6 is a screen shot representation of talents according to an aspect of the present invention;

FIG. 7 is a screen shot representation of talents according to an aspect of the present invention that permits further information to be displayed regarding the assets for a given talent;

FIG. 8 is a focused view on a particular asset of a talent according to an aspect of the present invention;

FIG. 9 is an image of the metrics according to an aspect of the present invention;

FIG. 10 is the image of FIG. 9 with an additional dialing in on a specific time frame, displayed as Apr. 2, 2008;

FIG. 11 is the image of FIGS. 9 and 10 with an additional dialing in on a specific time frame, displayed as Jul. 9, 2008;

FIG. 12 is the image of FIGS. 9, 10 and 11 with an additional dropdown menu displayed;

FIG. 13 is parameters of the displays of FIG. 9-11;

FIG. 14 is the images of FIGS. 9-11 when the coverage selected has been the DMA of Philadelphia, Pa.;

FIG. 15 is the images of FIGS. 9-11 with additional selections that be made with regard to the comparison brands to be used;

FIG. 16 is the images of FIGS. 9-11 with additional selection of the brands to compare with;

FIG. 17 is the display of FIGS. 9-11 and the ability to effect the qualitative factors that comprise the metrics score; and,

FIG. 18 is the display of FIGS. 9-11 with the possible ways to display the data;

FIG. 19 illustrates an exemplary embodiment of the present invention;

FIG. 20 illustrates an exemplary embodiment of the present invention;

FIG. 21 illustrates an exemplary embodiment of the present invention;

FIG. 22 illustrates an exemplary embodiment of the present invention; and,

FIG. 23 illustrates an exemplary embodiment of the present invention.

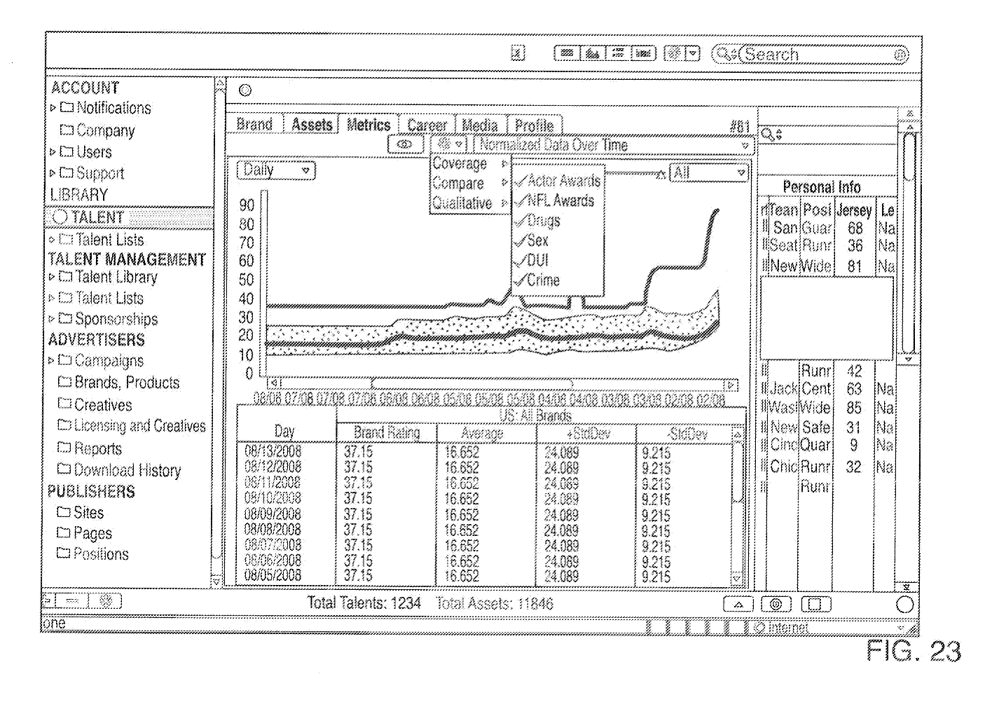

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical advertising engines, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

The measurement and management of brand value, which may simplify any transaction involving an endorsement as will be understood by those skilled in the art, has become a significant issue for marketers and marketing researchers over the last several years. The concept of brand value and brand equity goes well beyond the legal concept of a trademark, or the accounting concept of goodwill. Brand equity encompasses intrinsic values, or equities, that add to the tangible, measurable benefits delivered by a particular product or service. These intrinsic equities may include such things as the image imparted to the purchaser, advertising quality, advertising quantity, trust, long term reputation for reliability, customer support, social responsibility, and so forth.

The key challenges in Brand Value/Brand Equity measurement include: (1) measuring the importance of “brand” in the consumers product selection process; and (2) dissecting that measure of “brand” and determining its key contributing components.

Consumers may see a particular brand name as a contract. That is, a brand's name may reduce consumers' sense of uncertainty, allowing the consumer to purchase uncertainty reduction, or trust, thus improving a sense of value. Promotion of a brand can address, for example, price/costs, tangible brand attributes or intrinsic brand attributes (equities). Brand equity is typically communicated using consistent visual cues and consistent messages, thus allowing the consumer to quickly and efficiently distinguish between brands and their intrinsic product attributes. As a purchaser considers tangible product features in concert with brand equity (and price), he/she arrives at a set of products in a category that he/she will consider for purchase (i.e. their consideration set). Thus, a brand's equity is dependent on effective communications to the target market(s), and brand equity can be improved to an extent with improved effectiveness of communications.

A brand's equity therefore becomes part of the tradeoff a consumer considers as the consumer first selects his/her consideration set, and then decides which product or service to purchase. That is, purchasers actively trade off both the perceived tangible benefits and the perceived intrinsic benefits delivered by products in a consideration set against price, to arrive at the purchaser's value hierarchy, and ultimately the purchase decision.

Brands that have high perceived value are always included in a purchaser's consideration set. If a brand's combined tangible and intrinsic equities are consistently higher than any other brand in the category, that brand will generally have the highest customer loyalty in terms of purchase, repurchase, and recommendation. Competing brands can only improve their loyalty against the brand equity leader by lowering price in the short term, improving their product's tangible features in the mid term, and/or improving their brand's intrinsic benefits, or equity, in the long term.

A challenge to both marketers and marketing researchers is determining how to measure and manage the intrinsic value of a brand (its equity), and how to tie that value with attempts to improve value to customer loyalty.

Recent literature addressing brand equity indicates that there are several different approaches to measurement. Brand equity can be addressed at either the corporate level or the category level, and can also be addressed using internal data or external data. At the corporate level, brand equity can be assessed using internal financial data from a firm's accounting system, or it can be assessed using comparative financial performance data from similar firms (i.e. external). At the category level, a firm can address brand equity using unit profit margins, such as in comparison to unit marketing costs and/or in comparison to the costs of other products in the category. Alternatively, the firm can use consumer surveys to measure the perceived value of the product/brand compared versus other products/brands in a category.

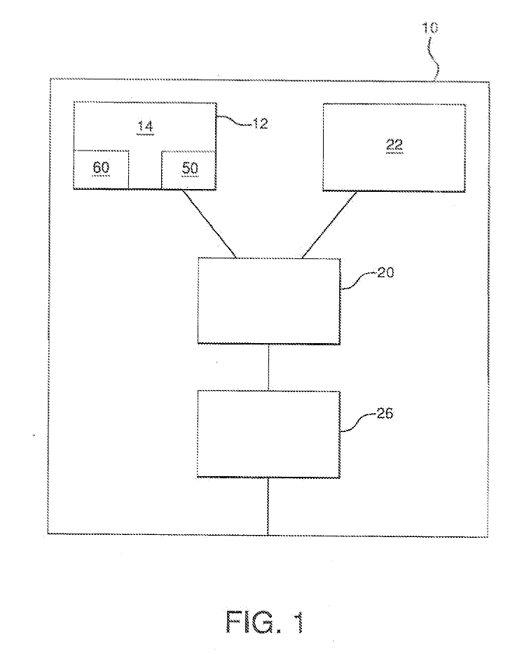

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets with or without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, early or late stage binding of the ad 22 and media asset 16 for delivery to strongest target consumers, and/or delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

The delivery engine 26 may also coordinate for the delivery of assets or creatives based on request criteria, such as in a pre-bind or late bind embodiment. An asset may, for example, be suitable for delivery without an accompanying creative for use with particular parameters. The recommendation engine may receive a request for an unidentified or non-specifically requested asset to be delivered by the delivery engine 26 in accordance with a set of request parameters. These parameters may include information such as geography, time of day, type of end creative, type of asset, monetary limit, and the like. In this way, a request may be made for an unknown asset to maximize a particular set of known parameters. By way of non-limiting example only, a request may be made to the present invention for an asset to be used in a condom advertisement which will be run at 2 a.m. in the city of Seattle, Wash. State. Such a request may ultimately yield a headshot of a local athlete meeting the parameters for further use in, or delivery of, the creative.

The recommendation engine may delineate the recommended asset(s) by, for example, type of advertisement. For example, a local radio personality may have pre-authorized the use of his asset with creatives surrounding contraception, while none of the players on the local professional football team may allow such a use. All other parameters held constant, the recommendation engine may work with the delivery engine 26 to deliver to the requester not only the asset that best fits the requester's parameters, but other assets that may similarly fill the request parameters. This type of alternative offer may also extend to situations where no asset meets the request parameters. In this case, the recommendation engine may provide, counter offer, or offer, to the requester, a series of assets that fail to meet, or exceed, the request. Similarly, even if an asset meets the request parameters, multiple assets may be offered in the attempt to provide greater selection or to provide the requester the ability to purchase an asset of greater value than previously requested, such as in an up-sell effort.

As discussed above, the delivery engine 26 may deliver the recommended asset only. The asset to be used in accordance with the request parameters. The delivery engine 26 may also combine an asset and creative for delivery as a single creative if the request parameters allow for this action. Additionally, the allowable asset may ultimately dictate the creative. The asset may have its own parameters which allow for its joining to only a finite type of specific creatives, which may in turn, continue to satisfy the request parameters. In this way, the requester may not just have available a certain collection of assets, but may have a selection of creatives as well.

When an asset or asset/creative bundle is delivered in this manner, the requesting party may be provided the opportunity to reject the offering. Such a rejection may end the transaction or prompt the system to provide at least one more possible asset or asset/creative bundle. This acceptance or rejection may allow the requester to be the final arbiter over the content of the media used and the cost of such media. This process may also allow the requester to reject assets that do not combine or work well with the creative held by or desired by the requester or other third party. As further discussed herein, the system may further track the usage of the delivered asset or asset/creative bundle to ensure compliance with the request parameters. This tracking may also include feedback, including metrics surrounding demography, hits, time of day, successful click through, etc. This information not only allows the system to measure the success of the asset or asset/creative, it also informs the recommendation engine. Such metrics may allow the recommendation engine to further assess recommendations with regard to the use and success of the asset in a similar scenario and to improved the value and efficiency of the system overall as discussed more fully herein.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and day part information. Gathered data intelligence may be used as individual properties in conjunction with each other to form or produce the level of intelligence needed to achieve the desired efficiencies. By way of further example, data intelligence may also include information regarding the number of impressions an ad has received, and the elapsed time between an impression or a click.

Utilizing data intelligence may allow the delivery engine 26 to optimize targeting to new and past targets. Optimization may include efficiencies of time and control over redundancies and ad targeting. Optimization will allow for the prediction of probable impressions or clicks that a certain ad or creative may receive when, for example, pointed towards certain factors, such as demographic and geography, for example. A prediction may also be made regarding the efficiency of paid searches and may be further contrasted with, for example, display ads. Such information as drawn from the data intelligence may also allow for the higher success rates related to redundant ad placement based on the prior behavior of a particular audience. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity.

The delivery engine 26 may also choose to deactivate and/or modify certain creatives based on data intelligence and/or user direction. By way of non-limiting example, the data intelligence may be collected from several ad or creative types over any number of varying media formats, allowing for even more sophisticated optimization based on the allocation of impressions and clicks in the various media formats. Media formats may include, but are not limited to, internet, TV, radio, mobile devices, kiosks, billboards, product placements, and print. By further way of non-limiting example, data intelligence gathered during a run of a creative on the radio may affect the play of an ad on the internet. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through. Such optimization may be done in real time and over multiple media types. The optimization may, by way of further non-limiting example, call for the addition of ads or creatives not currently apart of the campaign(s). Thus suggesting what type of ads or creatives is required for maximum optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted variables, thus maximizing the value of the placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

Further, it is known in the existing art to engage in a myriad of different types of advertisement online. Two such advertisement types are: a search advertising model, in which a user undertakes to search for a good or service of interest and receives, as part of or as indicated with a search result(s), advertisements relevant to purchasing the good or service for which the search was made and/or to purchasing goods or services related to the good or service for which the search was made; and a display advertising model, in which a user is actively viewing a web site and receives, as part of the web site under review, advertisements for the purchase of goods or services relevant to the content of the web site under review. Needless to say, the former operates on the principal that, if a user searches for a good or service, he/she would like to buy that good or service, and the latter operates on the principal that if a user is interested enough in the content of a web site to view that web site, he/she is also likely interested in buying goods or services related to the content of that web site.

The display advertising model mentioned hereinabove is typically embodied as banner on a web site. For example, such banners may appear above, below, to the left, or to the right of the content being viewed, but typically do not impinge upon the content being viewed. The search advertising model mentioned hereinabove is typically embodied as advertisements/banners placed proximate to search results on the search results page responsive to the user search. For example, such advertisements may appear along a right hand side of a search results page, while the search results are displayed along the left hand side of the same search results page.

As discussed immediately above, it is necessarily the case that the correlations performed between the user's searched or viewed content and the advertisements provided will increase the relevance of, and thus the response to, the advertisements. However, such responses in the form of either clicks on the advertisements or purchases made through the advertisement link, once obtained at a particular rate, cannot be further improved by the relevance of the advertisements produced. Rather, the only manner to improve the response rate once relevant advertisements are produced is to improve the advertisements themselves based on the users viewing the advertisements.

The present invention provides such improved response advertisement through the provision of brand affiliations with the goods and services being advertised, as discussed herein throughout. As discussed, the present invention allows for the production of advertisements having brand sponsorship that is optimized to the market sought. That is, the brand sponsor selected for an advertised good or service is, though the use of the present invention, selected to best correspond to the characteristics of the purchaser sought by the advertisement.

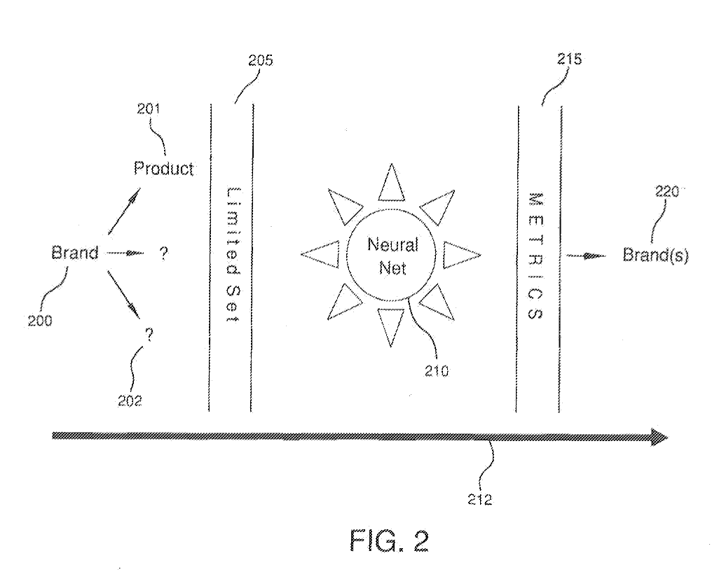

Referring now to FIG. 2, there is a rendering of the operation of an aspect of the present invention. As may be seen in FIG. 2, there is a brand 200 that may relate at least in part to a product 201, and potentially other products 202. The brand 200 and products 201 may be monitored for information about brand 200 or product 201, such as information in the media, such as the limited set 205 that contains a set of references found in the media or through other outlets that provide information that is effective in the neural net 210 of the present invention. This neural net may allow for and monitor metrics 215, and may ultimately produce a branded advertisement or schedule of advertisements and endorsements, or a branded application 220. The neural net 210 may provide an integration of a plurality of metrics to one or more asset selected as a limited set from among all brands of assets. The neural net may effectuate decisions as to what assets, or mentions of assets, are to be rated, what such ratings are, what statistics are applied to, or in light of, such ratings, correlations or estimations of value based on such ratings, and the like. Specifically, neural net 210 may act to provide metrics 215 using the limited set 205 of information about brand 200 or products 201, for example. In so doing, the system of the present invention may provide brand application 220.

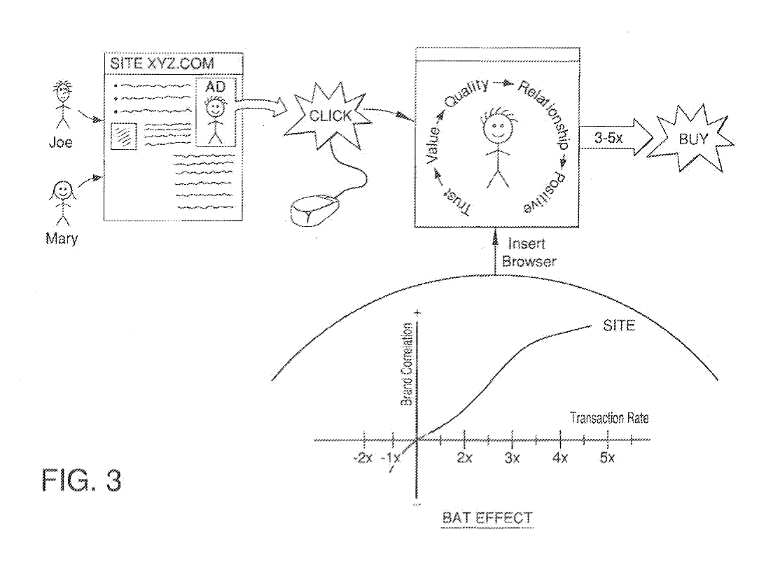

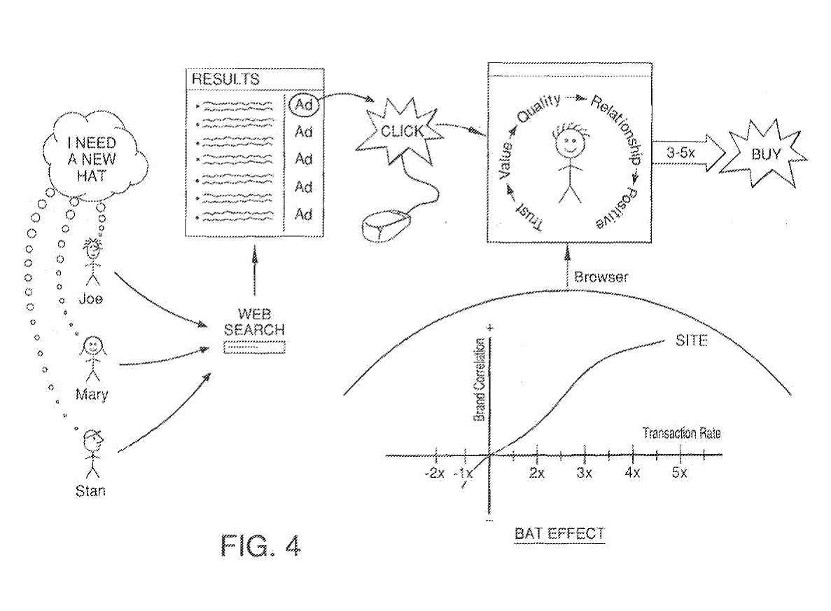

Selecting the best corresponding brand sponsor for an advertised good or service is illustrated with respect to FIGS. 3 and 4. FIG. 3 illustrates the effect of the present invention with regard to a search advertising model, and FIG. 4 illustrates the effect of the present invention with respect to a display advertising model. In each Figure, a brand sponsor has been selected who will indicate, to the user for whom the advertisement is deemed most relevant, trust, quality, value, a relationship to the user, and/or an overall positive feeling. The sponsor is either selected by the advertiser in the present invention for inclusion with the subject advertisement, based on the profile of a desired purchaser and the characteristics of that sponsor as they relate to that profile, which relation is set forth or suggested by the present invention, or the sponsor is selected by the present invention for inclusion in or with the subject advertiser's advertisement based on a desired responder profile for the advertisement entered by the advertiser to the engine of the present invention.

As illustrated graphically in FIGS. 3 and 4, a positive correlation of a brand sponsor to a brand, which is necessarily also a correlation of a brand sponsor to those purchasers most interested in buying the subject brand, correlates positively to an increased transaction rate. In other words, to the extent the present invention provides brand affiliations, sponsorships, and the like that are well-suited to the sponsored brand, that brand will show an increase in the number of users who are shown that advertisement and that either click that advertisement or purchase that brand through that advertisement. It is estimated that the increase in the desired response rate in accordance with the use of the present invention may typically be a 3 to 5 times increase, based on the increased positive correlation between the sponsored brand and the brand sponsor provided by the present invention, although those skilled in the art will understand that more or less improvement in the transaction rate may occur based on the implementation of the present invention.

Thus, in accordance with the present invention, and as illustrated in FIGS. 3 and 4, an increased correlation of a brand sponsor to a sponsoring brand, and thus an increased correlation of a sponsoring brand to a desired purchaser's profile, is provided. This increased correlation generates an improved transaction rate in accordance with the present invention, for at least a search advertising model and a display advertising model.

In one embodiment of the present invention, a counter offer may consist of offering a different media asset than the one originally requested by the requester. The counter offer may comprise a barter offer, that is, an offer for an exchange of other than monetary compensation, such as of exchanging advertising space for use of an endorsement. The counter offer may also consist of varying the bartered asset by, for example, altering the size of the space offered, the time the space will be available for use, and/or the number of views provided by the space or spaces offered. In this aspect, the recommendation engine may take into account various types of metrics such as demography, hits, time of day, successful click through, etc.

Returning now to FIG. 2, and in light of FIGS. 3 and 4, as used herein, a metric is a standard unit of measure, such as mile or second, or, more generally, is an aspect of a system of parameters, or of one or more systems of measurement, or of one or more of a set of ways of quantitatively and periodically measuring, assessing, controlling or selecting a person, process, event, or institution. A metric additionally includes procedures to carry out measurements and the procedures for interpretation of an assessment in light of previous or comparable assessments. Metrics may be specific to a certain subject area, in which case they are valid only within a certain domain and cannot be directly benchmarked or interpreted outside it.

More specifically, in the system of the present invention, metrics may be used to provide information regarding an asset, such as a prospective endorser. Specifically, each asset may have assigned thereto one or more metrics corresponded to a rating of the asset. This rating may allow for a valuation of the asset.

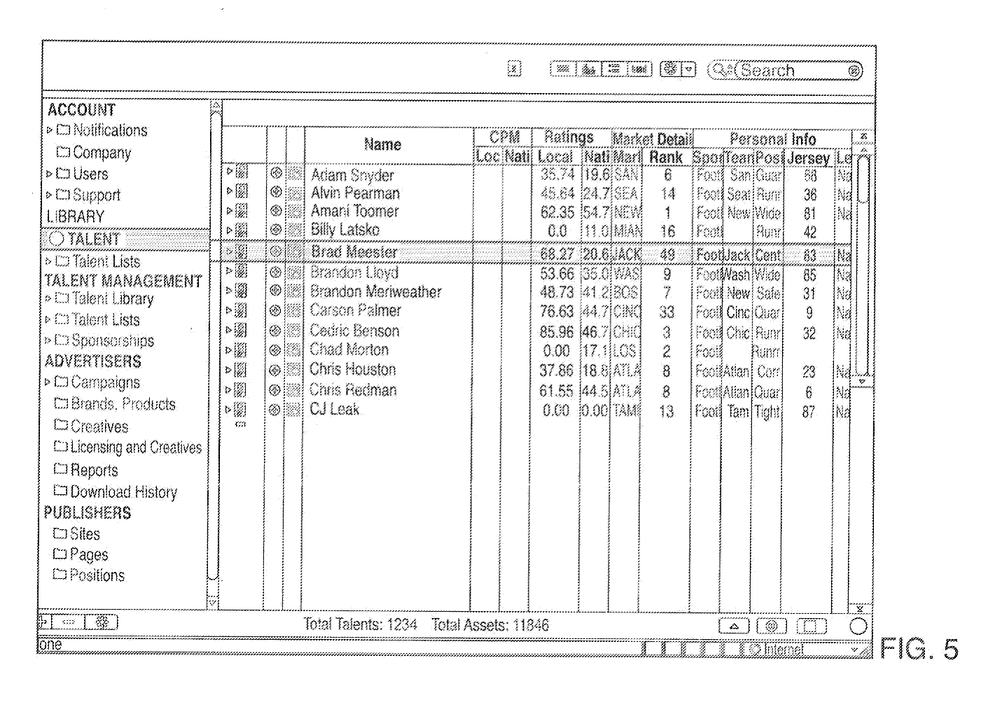

Referring now to FIG. 5, there is shown a screen shot according to an aspect of the present invention. As may be seen in FIG. 5, the vault may provide information of a talent library, which talent library may be or include a plurality of assets accessible, for example, via a recommendation engine interface. Within the talent library, in the situation where the talent at issue is individuals, there may be provided a listing, illustration, graphic, menu, or search interface of and for the given talent. Associated with the listing of the talent may be personal information such as sport, team, position, jersey number, league, college, height, weight, by way of non-limiting example only. Also, information concerning the market and/or marketability of the named talent and/or the ranking of the named talent, such as by market and/or geography, may be made available. Such rankings or marketability ratings may take the form, as would be known to those possessing an ordinary skill in the pertinent arts, of a ranking with 1 being the highest ranked, or with 1 being the lowest rank. Alternatively, other rankings schema may also be used. As may be seen in FIG. 5, there may be provided information regarding ratings that is referenced on a local and national level, in one market versus another, of one asset versus another, or the like.

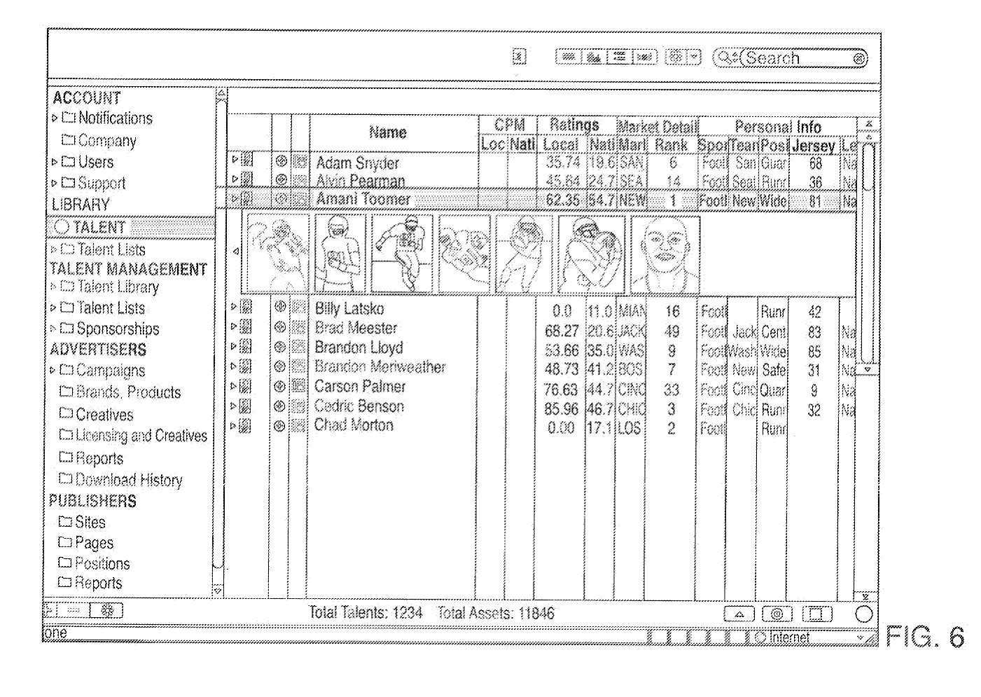

Referring additionally to FIG. 6, there is shown a representation of talents according to an aspect of the present invention. As may be seen in FIG. 6, there may be available a drill down for an asset, such as in the drill-down of Amani Toomer as the talent, through which may be provided additional or secondary information to minimize clutter in the primary display of assets, such as various pictures and clips of mpegs may be seen. Those illustrated are the specific assets for the talent that is Amani Toomer in this exemplary embodiment.

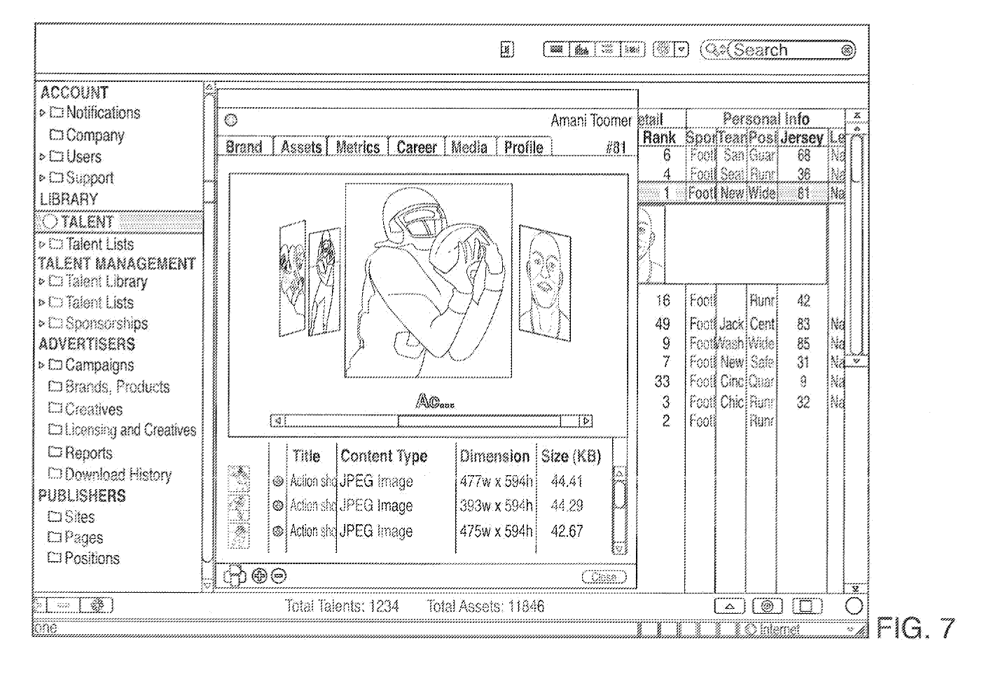

Referring now additionally to FIG. 7, there is shown a representation of assets according to an aspect of the present invention, wherein further information regarding assets for a given asset talent is displayed. As may be seen in FIG. 7, the assets for the selected asset talent may be displayed in a shuffled-card format, wherein one asset may be displayed prominently in the middle with each side displaying other assets in a turned/side type view. From this perspective, more information may be displayed for each asset, such as a title of asset, the type of asset, dimensions and size of a picture of an asset, by way of non-limiting example only.

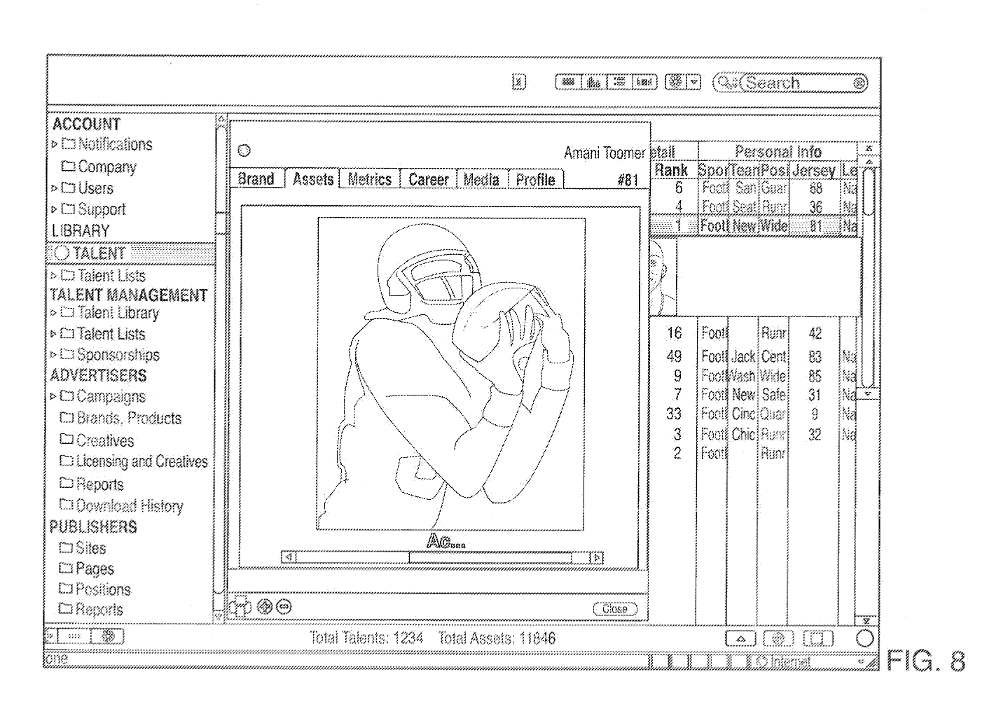

Referring now to FIG. 8, there is shown a focused view on a particular asset according to an aspect of the present invention. In this particular case, FIG. 8 shows an asset of the asset talent Amani Toomer catching a football in an action shot. This particular image may be a still image taken of a catch, or may be a frozen frame of a movie asset, for example.

Turning now to metricizing an asset, a metric may be constituted by any of a plurality of methodologies of valuing the marketability of an asset. For example, a metric may be determined by searching to look up brands, wherein any word, or specifically proper noun, is effectively a brand, particularly on the internet, for example. The results of a brand search may be stored, and a metric computed therefrom by reviewing data collected in the brand search. For example, domain lookup and page information may be reviewed in a database. From the domain and page information, the system of the present invention may infer information, such as based on information available regarding consumership or the subject domain or page. For example, if in the database it is known from available information that a certain percentage of readers of the domain “Technology Innovations Weekly” are engineers/scientists, or the domain “Baseball World” are males under the age of forty, the system of the present invention may infer information regarding viewers of that page, and thereby underscore a computation for a metric according to inferred information as applied to the brand referenced by the page. Further, for example, the page rank from a search engine may also be used to infer popularity of a page to thereby provide a metric of the brand asset based on the page on which the brand is found, i.e. popularity with which the asset brand is viewed.

Google® trends may also be used to metricize a given brand. Google® trends charts how often a particular search term is entered relative the total search volume across various regions of the world, and in various languages. Often, the display of Google® trends may illustrate a horizontal axis representing time, and a vertical representing how often a term is searched for relative to the total number of searches, globally. The data may be graphed with popularity broken down by region, city and/or language, for example. It is also possible to refine by region and time period. Google® trends may also allow comparison of the volume of searches between two or more terms. An additional feature of Google® Trends is in its ability to show news related to the search term overlaid on the chart showing how new events affect search popularity. The above may provide data for a metric in accordance with the present invention. For example, Google® trends may be used to compare a certain brand against a baseline, such as all brands or all brands in a particular field, thereby allowing for calculation of a “buzz” relative to other brands. Additionally, an interpolation of trends against known qualities of a certain domain increases the level of detail of the popularity of that domain and its brands with the sects of population associated with the qualities of the domain. Further, for example, if searches for a certain online newspaper are known, and a second newspaper has half the readership of the first, it can be interpolated that searches for the second paper are half in number of those for the first, and thus the second paper is half of the first in overall popularity.

Further, other metrics may be made available in accordance with the above. For example, data may be gained regarding links that lead to the subject domain. Thereby, for example, the demographics of those linked domains may be included in the analysis of the subject domain. Additionally, closed captioning may be metricized, such as for TV and radio. Closed captioning allows for a textual presentation of all brands (proper nouns) mentioned on TV and radio. With knowledge of viewership or listenership, such as via Nielsen ratings for TV, monitoring of data regarding mentions, such as via monitoring closed captioning, allows for knowledge of what percentage of viewers/listeners were presented with a brand mention, and whether the mention was good or poor. Further, the demographic data available regarding viewers and listeners allows for an interpolation of the brand mention along demographic lines.

Survey data may also be used to quantify the metric of a given brand. Surveys may be used at each level of branded product development. Specifically, surveys at the category level to measure brand value and brand equity may be used, then that information may be used to aggregate brand equities to the corporate level. Such use of surveys may allow a metricization of the brand metric score.

Similarly, positive or negative mentions of assets may be tracked, such as by monitoring online text via/and/or monitoring RSS feeds. Such mentions may be rated, such as by offline manual rating of each mention, and such as by comparison to lists of good or bad non-proper nouns used in conjunction with the asset. Such ratings, of course, constitute a metric.

Likewise, a gross number of views or listens may be tracked, such as by using domains that provide such information, such as YouTube. Such information allows not only for a gross metric with regard to an asset, but further, if used in conjunction with, for example, demographic or geographic information, allows for one or more detailed metrics.

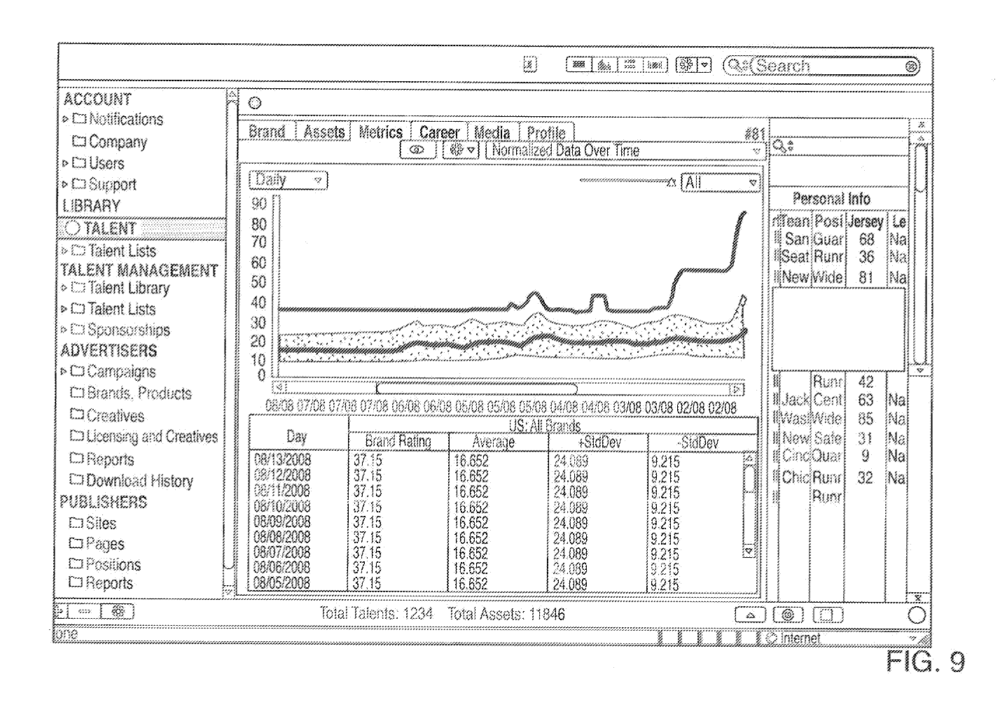

Referring now to FIG. 9, there is shown an exemplary presentation of metrics according to an aspect of the present invention. As may be seen in FIG. 9, a graphical display of a metric score as a function of time may be displayed for the asset of interest—that is, a brand rating. This can be overlayed with a graphical presentation of the average of all U.S. brands, for example, and may include a shaded plus/minus a standard deviation of the metrics score of all U.S. brands, for example. Similarly, a tabular display of this information may also be presented, in this case below the graphical display.

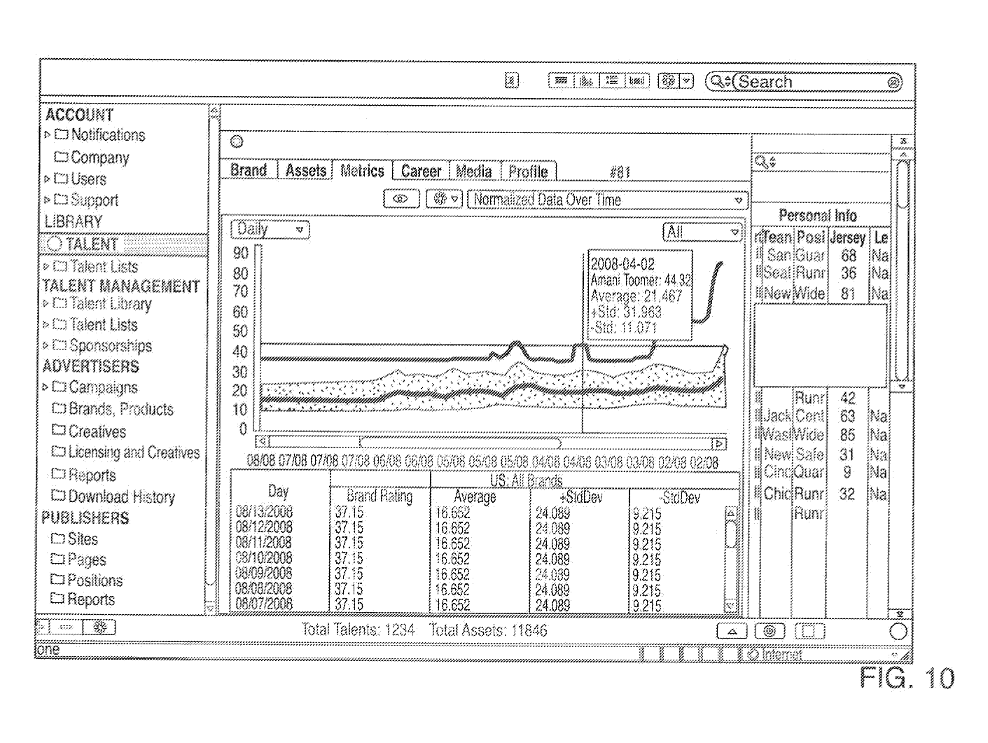

Referring now to FIG. 10, there is shown the image of FIG. 9 with an additional focus on a specific time frame, displayed as Apr. 2, 2008. The data on that specific day is graphically illustrated for an asset graphical display of interest metrics as a score of 44.32, with an average of all U.S. brands metrics score of 21.467, and with a +std of 31.863 and a −std of 11.071.

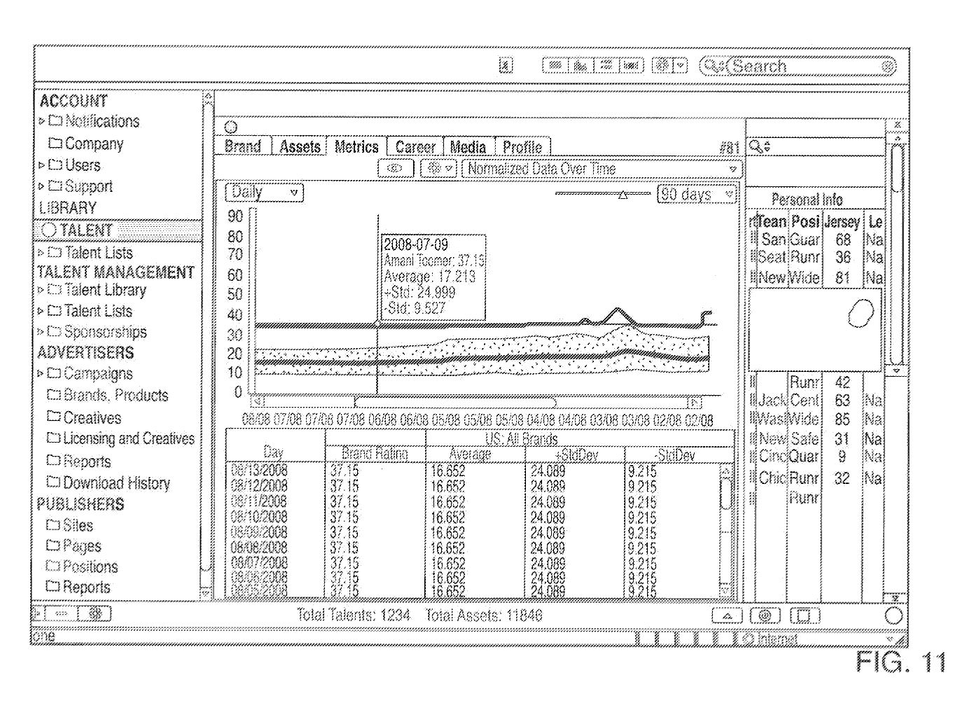

Referring now to FIG. 11, there is shown the image of FIGS. 9 and 10 with an additional focus on a specific time frame, displayed as Jul. 9, 2008. The data on that specific day may be displayed as illustrated.

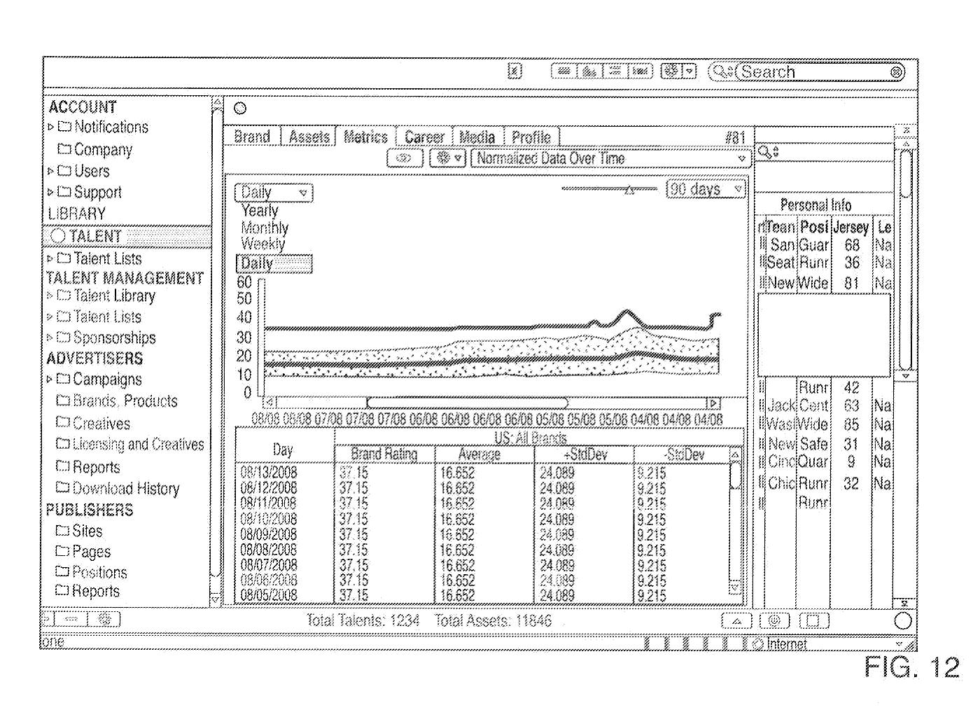

Referring now to FIG. 12, there is shown the images of FIGS. 9, 10 and 11 with an additional dropdown menu displayed. The specific dropdown menu displayed in FIG. 12 relates to the display and computation associated with the metrics of FIGS. 9-11. Specifically, the drop down may provide as to whether the metrics are calculated yearly, monthly, weekly or daily, for example.

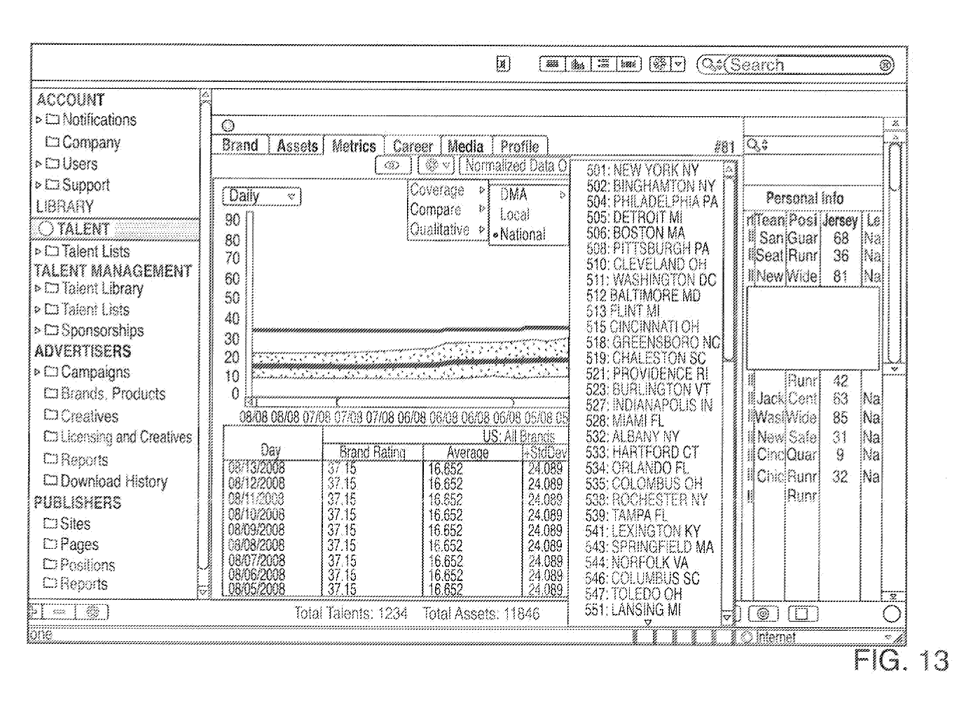

Referring now to FIG. 13, there is shown a plurality of parameters based on the displays of FIGS. 9-11. The coverage that is selected may be modified to select a specific region of the world. Specifically, regions of the United States may be selected, such a Baltimore, Md., for example. For example, a DMA, local, or national area may be used. DMA is an acronym for Designated Market Area. DMAs are a way of designating particular geographic markets, and are often ranked by size of population. The graphical presentation may also be based on a zone, such as a local area or subset of a DMA.

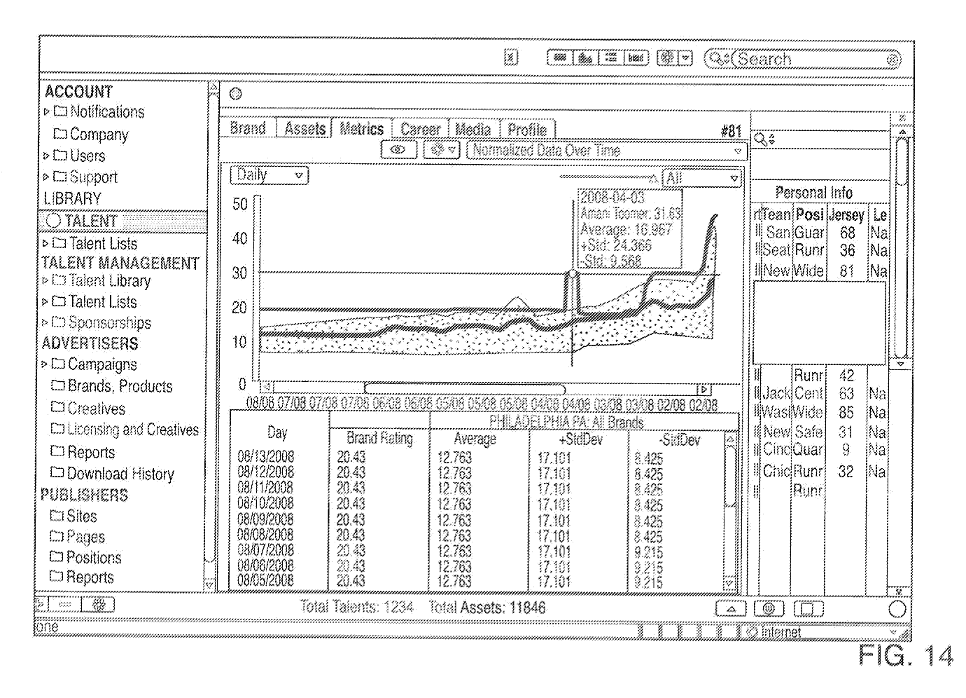

Referring now also to FIG. 14, there is shown the image based on FIGS. 9-11 when the coverage selected has been the DMA of Philadelphia, Pa. In such a scenario, the graphical interface computes and displays the metrics score of the asset selected as a function of time, and also plots the average of all brands in the Philadelphia DMA with associated standard deviations.

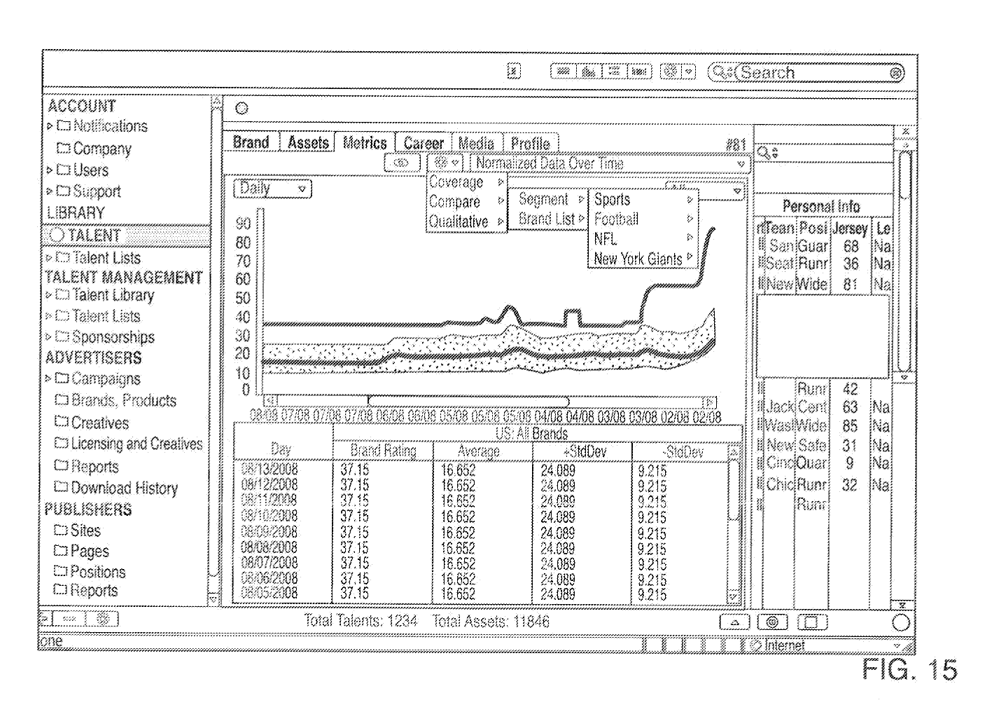

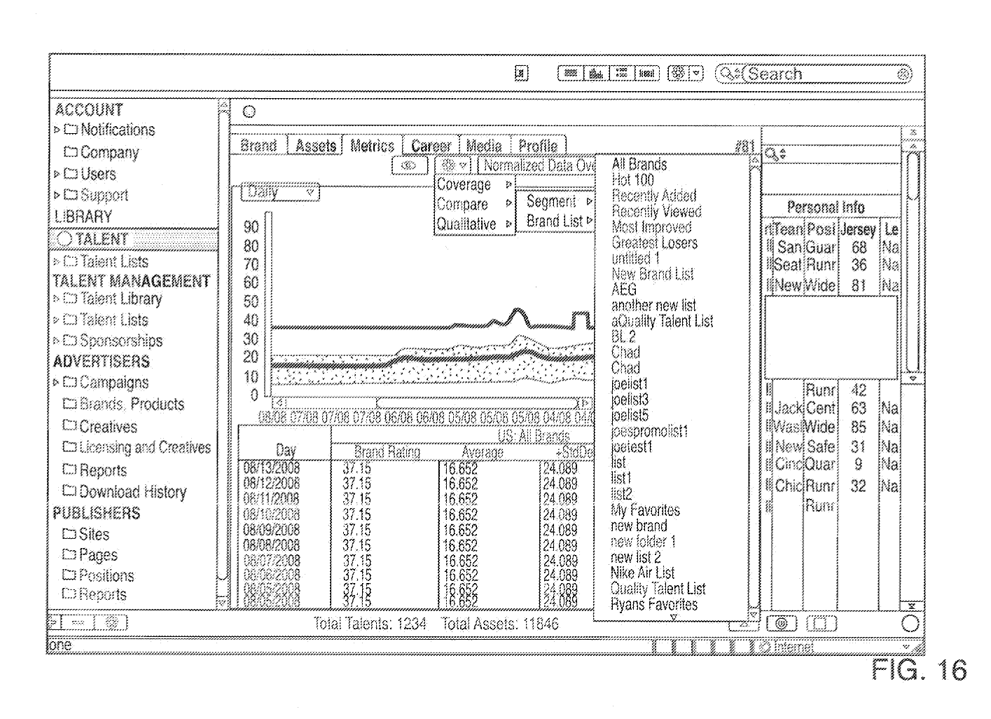

Referring now to FIG. 15, there are shown additional selections that may be made with regard to the comparison brands to be used. For example, it may be beneficial to compare to only brands within a segment, such as in a situation wherein the segment has been subjected to some unique circumstance, for example, or wherein a specific positive incident, like the Super Bowl, may have an effect on all football brands, for example. Further, a comparison may be made to a specific brand as well. Referring now also to FIG. 16, a selection of the brands to compare with is shown. This may include most improved brands, hot 100, recently added, and recently viewed, by way of non-limiting examples only.

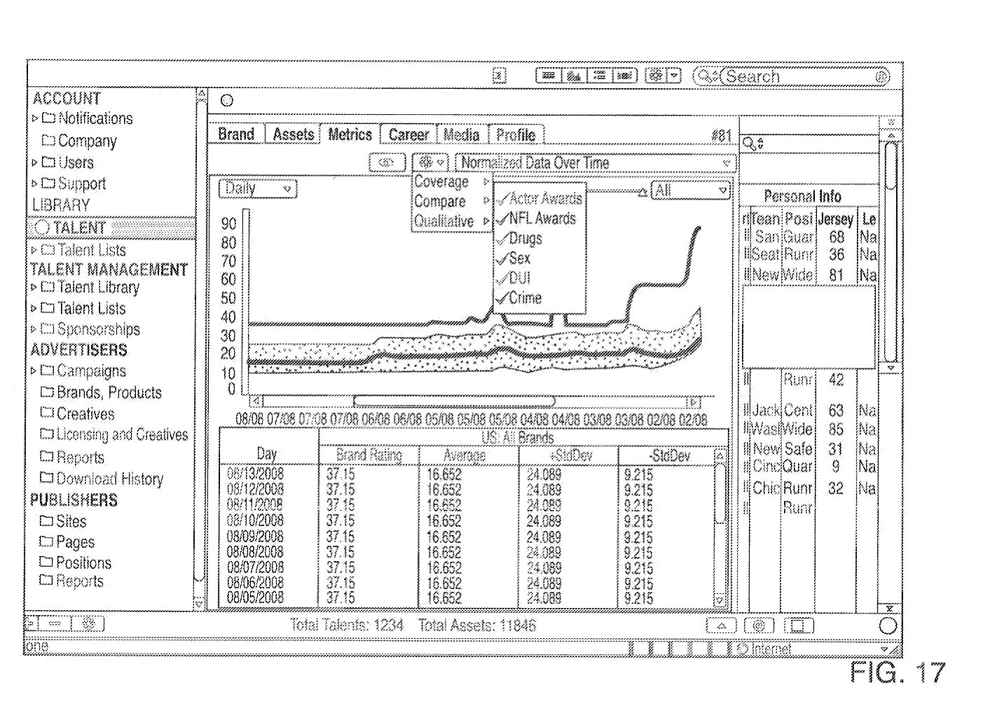

Referring now to FIG. 17, there is shown the ability to affect the qualitative factors that comprise a metrics score. As described hereinabove, metrics may be computed a number of ways and may further include components associated with awards, drugs, sex, dui, and crime, for example. The metrics score may be examined with selected ones of these filters removed or included as desired.

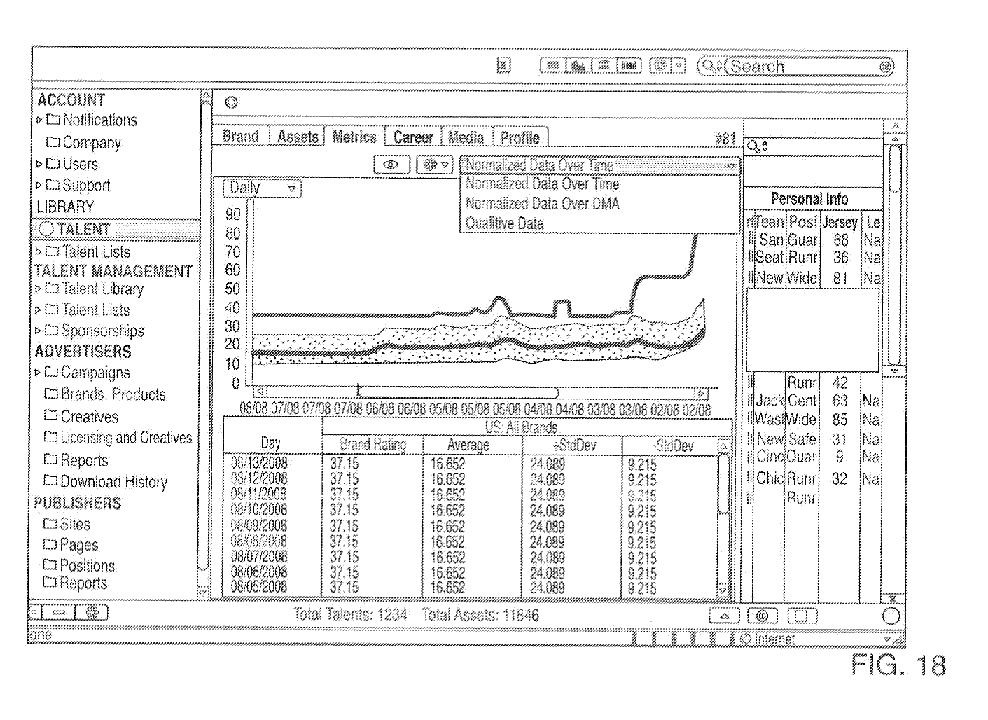

Referring now to FIG. 18, there is shown the display of FIGS. 9-11 with several possible ways to display the data. For example, data may be displayed in normalized data over time, normalized data over DMA, and qualitative data, for example.

The present invention also provides for the comparison of metrics for assets for which metrics are tracked or are otherwise computed. As previously mentioned, metrics may be continuously collected and calculated for a given asset. In the most general sense, the present invention may further provide for the comparison of specific asset metric(s) to an average of those metric(s) within the system. More specifically, the present invention may provide for the comparison of any number of discrete asset metric(s) with one or more distinct asset metric(s).

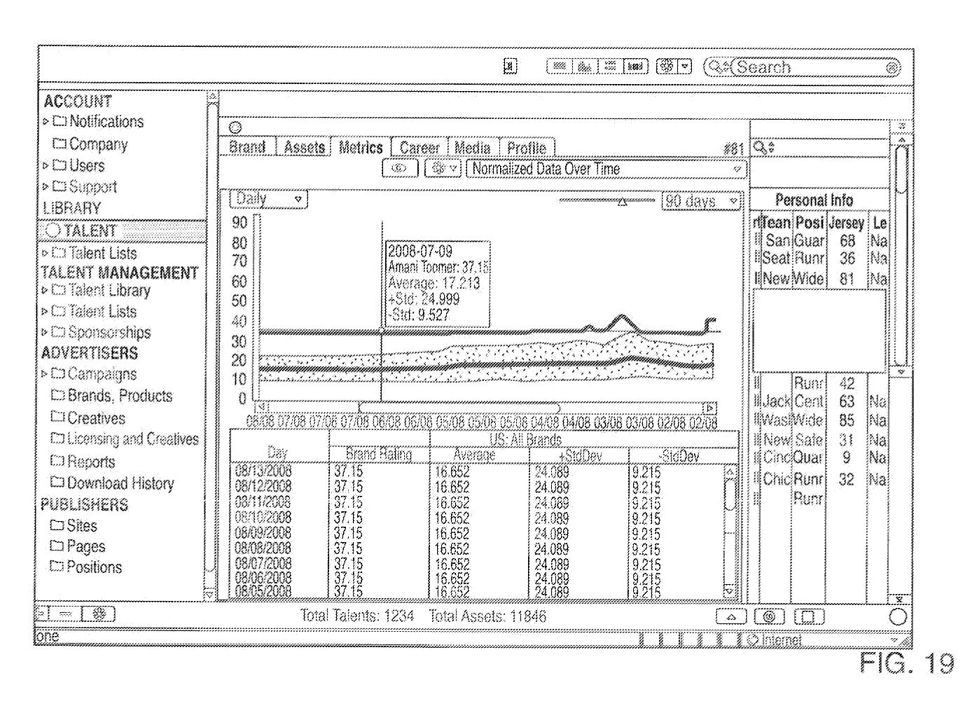

As shown in FIG. 19, a general value of the metrics for a specific asset may be continuously compared to the same metrics as averaged for all related tracked assets, whether in the system or not. The information may include a brand rating value for the asset, the average brand rating for related assets, and the various deviations or other comparison information. As further shown in FIG. 19, the brand value may be calculated (and compared) for an asset across all national metrics and against a specific time period. Although the time period may be viewed in hours, days, weeks, months, and years, a standard view of ninety (90) days allows for the viewing of changes in the asset brand value and the average brand value. Further, the system allows for “pin-point” assessment of the brand value which may be viewed by hovering the cursor over a portion of the graph.

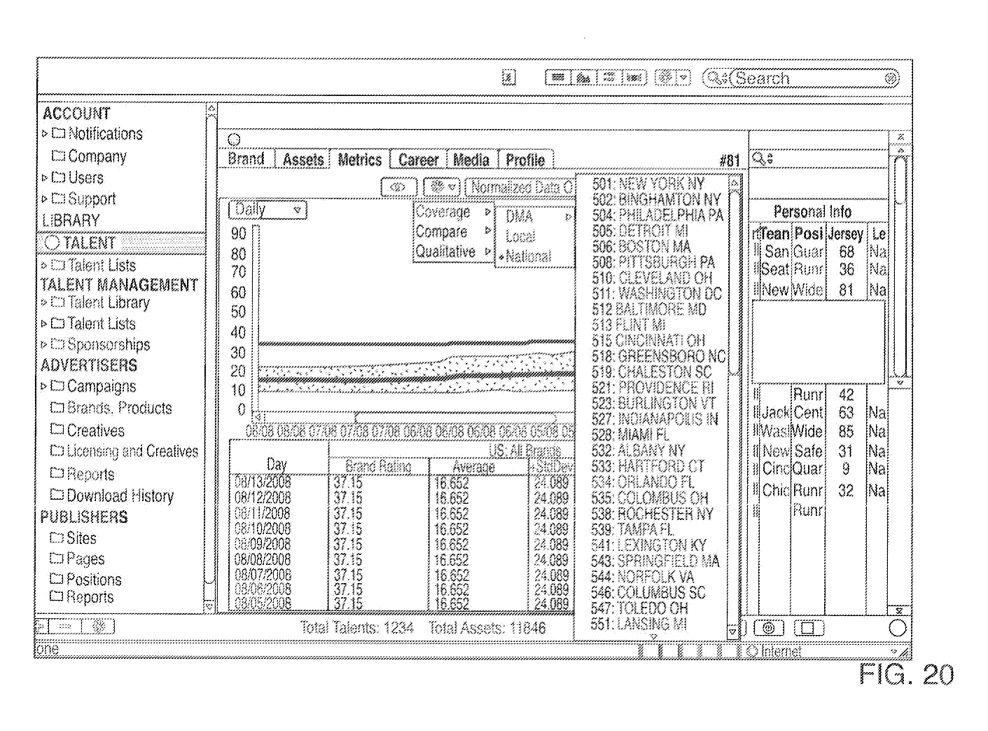

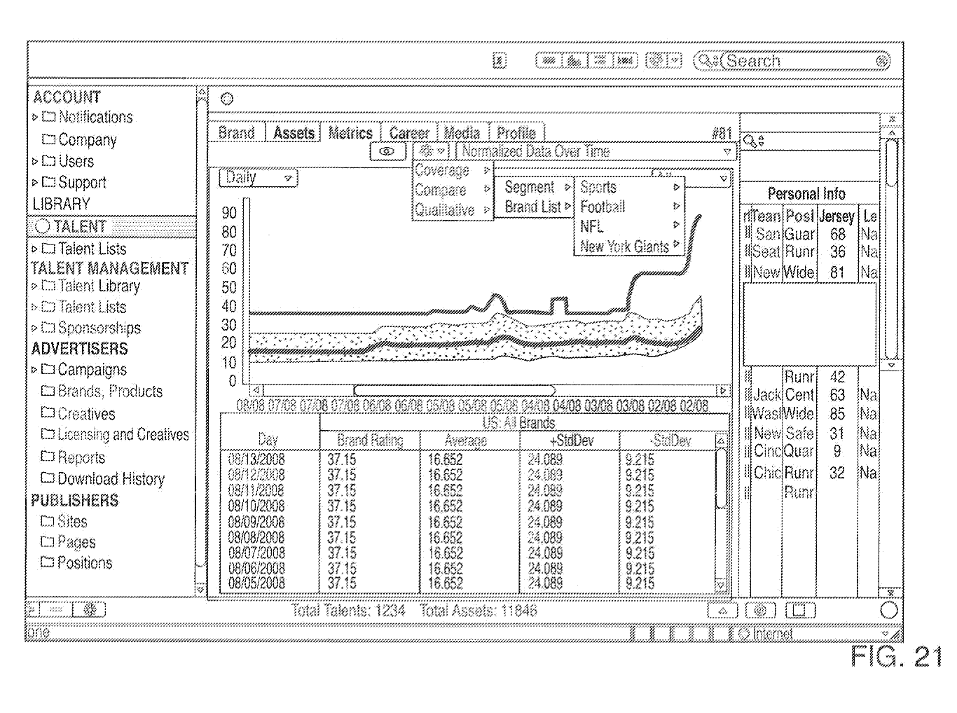

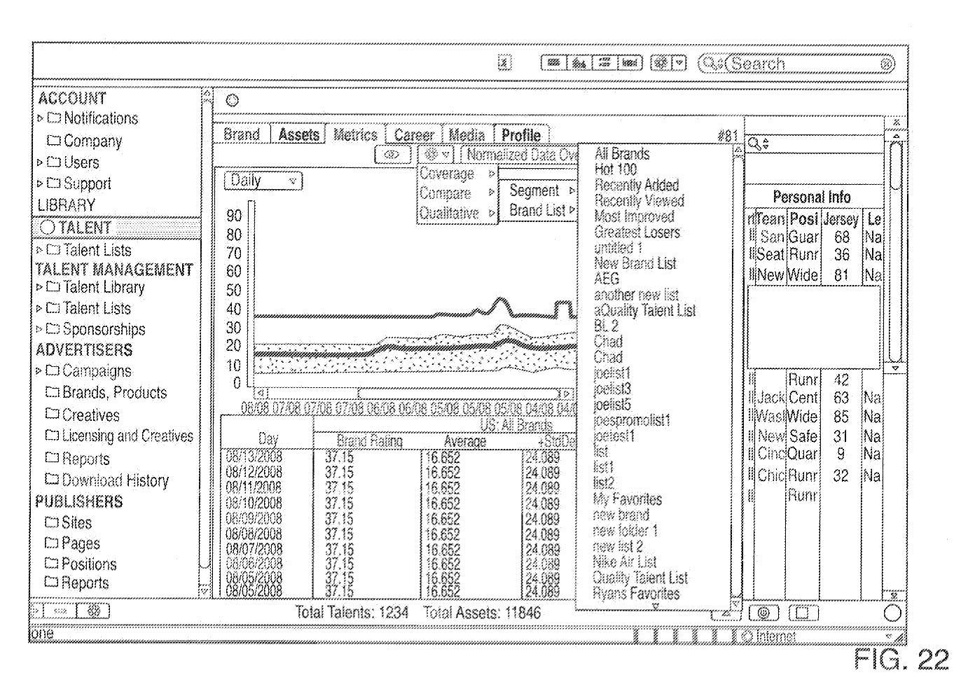

As shown in FIG. 20, the geographic area by which metric(s) may be valued for a particular asset may be changed and may encompass one or more DMAs. As illustrated in FIG. 21, metric evaluations may be valued, or further refined, by filtering for specific asset classifications, or, as illustrated in FIG. 22, through customized groupings of system and non-system asset(s) and/or metric(s). As previously discussed, the features provide the ability to compare and analyze at least one asset to at least one other asset in relation to at least one metric.

In an embodiment of the present invention, the rating of assets and comparison against each other provides for a listing of assets by brand rating score, all other delineations held equal. In this manner, a sudden drop in brand rating may cause at least one asset to fall in ranking. As discussed previously hereinabove, drops in brand rating may occur if attention is turned away from the asset, negative ratings affect the asset, and/or other assets spring gain in value, for example. By way of non-limiting example only, national events may devalue some assets by reducing measurable metrics related to the asset(s), such as a natural disaster in Louisiana which may dominate all news and the public's attention for a brief period of time. Similarly, a national event, such as the Olympics, may dominate the measurable metrics. In any case, the metrics of individual assets may be affected such that drastic value swings occur.

In another embodiment of the present invention, an asset's brand rating or comparison data may be displayed as a graphical representation of data where the values taken by a variable in a two-dimensional map are represented as colors, otherwise known as a heat map. Such a heat map may illustrate the relative values of brand ratings for an asset over a given dimension. For example, a heat map may be used to show the brand rating for a particular professional athlete over a geographical area, such as the continental United States. Such a heat map may show high, low and zero value brand ratings by DMAs, county, major cities, or in any breakdown which may adequately show the changes, if any, in the brand rating of the given asset. The present invention also provides for the overlaying of such heat map and “reverse heat map” which may indicate where negative metrics affect brand rating. Heat map overlays may also include overlays or other embedded data representing other empirical data, such as average brand ratings, population and demography statistics, and media viewership ratings, for example.

Although many forms of assets have been discussed, profiles and statistics may also become assets in their own rights. In each case, they may be linked to one or more distinct assets, whether or not a particular asset is made available by the system, or other profiles and/or statics. Further, each of a particular profile or statistic may be further grouped into modules to create super groups which themselves may create value, and in some cases sufficient value for the individual profile(s) and statistic(s) to reach an asset class.

More specifically, a profile may be developed around an existing asset. For example, information may be gathered about an asset and compiled to provide an information rich collection of data for the particular asset. This information may be gathered through the methods used to collect metrics, as discussed above, or through the use of profile specific building tools. These tools may include queries directed to the particular asset which may collect information related to the asset not otherwise gathered through the use of metrics. By way of non-limited example only, the asset may be requested or required to answer thirty (30) questions related to the market most related to the asset.

Furthermore, statistics gathered for available and non-available assets may also be valued as assets themselves. Although a particular asset individually may not necessarily be valued as an asset, a combination of statistics may be combined to form an asset. Such a combination may be one or more statistics related to an individual asset or any combination of statistics not necessarily related to any particular asset or grouping of assets. For example, professional athlete performance statistics may be compiled by player or by sport. By way of non-limiting example only, a compiled statistical asset may provide information related to the popularity of particular sports in a given geographical area. Similarly, a compiled statistical asset may provide information more detailed information such as the popularity of various sporting events and micro events in a given geographical area, DMA, or demography, for example. More specifically, for example, a compiled statistical asset may inform the user that a particular DMA in the western United States prefers watching golf events over all other sports. Similarly, a compiled statistical asset may show that each time a particular athlete scores or does something of merit, the local DMA becomes pre-disposed to the advertising around that particular sport, player, and/or team.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Further, there may be instances where the metricizing of an asset may have periods where the asset does not have any media attention. This could occur for example when a player is in the off-season, when a player retires, or during other periods where an asset is no longer in the media. Such a situation may occur when a sports figure, such as a hall of fame caliber player retires from the game. After the fanfare of the retirement festivities occurs, this player may be in the background while other ventures begin to materialize. Such other ventures may be at the early stage, because of the close proximity of the retirement, or because they generally are not news worthy. Such occurrences may keep quotes, statements or facts in the background.

Further, there are many sports legends that choose to live away from the public eye. One such example, Sandy Koufax, who played baseball from 1955 to 1966, was the most valuable player in the National League in 1963, won Cy Young Awards (at a time when only one award was given a year) by unanimous votes in 1963, 1965 and 1966, and in each year won the pitching triple crown by leading the league in wins, strikeouts and ERA, and pitched numerous no-hitters and a perfect game on Sep. 9, 1965 Mr. Koufax was a baseball broadcaster after his career until 1973, was elected to the hall of fame in 1972 as the youngest member ever to enter the hall of fame, has his uniform number 32 retired for the Dodgers, and is still a highly regarded athlete. But Mr. Koufax presently does not garner press coverage on a daily, monthly or yearly basis. Such an individual may still possess a very high metric score, even though current data would not support such a score. Having someone such as Mr. Koufax endorse a product might thus still be costly, but would also be considered great validation of the product in spite of the lack of recent mention or search metrics. As such, the system of the present invention may maintain a metricized score over a predetermined time frame, such as when that score reaches a certain threshold, or maintains itself at or above a score for a certain period of time, or when the score relative to others in that same profession, position, city, or the like, exceeds a certain threshold.

For example, the system of the present invention may provide a stability control to such individuals or assets during periods of decreased news activity, or periods where there is no activity on that asset. Further, the present invention may provide an exponential or linear component to the buzz, rating, or the like, of an asset, in either a increasing or decreasing fashion. By way of non-limiting example only, the system may provide a linearly decaying function in order to take the metric value of an asset to zero over a fifty year time frame, such that if the metric value prior to the inactivity period was fifty, this metric would decrease by one every year during the inactive period. Similarly, for an asset that has achieved unique status, such as a hall of fame credential, the asset may increase linearly each year as the asset develops a longer history in the field of the asset's endeavor. By way of further example, the asset's metric may decrease to a DC baseline, such that when new mentions occur, the mention plus the DC baseline becomes the asset's rating metric. Such a baseline may be half of the value of the average of the three highest metrics achieved for a one year period for the asset, for example. Needless to say, assets in different fields, such as sports versus entertainment versus Fortune 500, may have applicable thereto different formulae for the exponential or linear increase or decrease, over different times, of the metricized buzz rating associated with those assets. An asset metric may also include factual achievements, such as awards, championship appearances and wins, number of venue sell-outs, number of items sold, such as authored works and trinkets, for example. Such achievements may greatly impact an asset's value well beyond the actual achievement being measured. For example, a football team that wins several championship games in a row may continue to experience an elevation in its value even if several years of relative decline in performance occurs. Similarly, an artist who sells out a venue and/or has several albums go gold may experience an increase in value long after the events on which the increase in value is based upon occurred.

It almost goes without saying, in light of the discussion herein, that background information, such as licenses associated with a particular endorser, may be provided as an electronic asset associated, by at least one computing processor responsive to at least one computing code, with that endorser. But additionally, and as illustrated in FIG. 24, other pertinent information 872 associated with the use of that endorser 874 may be provided as a bucketized asset 872 associated with that endorser 874. For example, not only may the asset bucket 876 in association with a particular endorser include prior, current, and future proposed endorsement agreements 872a, b, c with that endorser, but additionally, to the extent required, such as to obtain all necessary approvals to work with that endorser, the asset bucket 876 may include any group licenses 872d necessary to work with that endorser 874 within that endorser's asset bucket 876. As used herein, a bucket preferably comprises computing code, wherein the computing code, upon execution, provides the bucket as a virtual repository for one or more items. The one or more items may include the electronic assets discussed hereinthroughout, for example.

The bucketized assets may, in a preferred embodiment, be visually available and selectable from a single access point, such as from a single folder, a tab, a drop down menu, or the like, associated with a display presented upon selection of an endorser. The single access point may provide links, such as hyperlinks to local or remote content, that link to the bucketized assets. Selection of such links may provide copies of the desired assets, such as pdf copies of past, present, or future endorsement agreements.

For example, use of a Major League Baseball player as an endorser may not only require an endorsement agreement between the advertiser and the subject player, but additionally may require a license with the Major League Baseball Player's Association (MLBPA) to use that player as an endorser. In such a circumstance, the asset bucket electronically provided for association with that Major League Baseball player may include, for example, prior, current, and/or proposed licenses with and from the MLB Player's Association for use with MLB players. Such a group license agreement asset may be provided within the asset bucket as an attachment, as a tab, as a drop down menu item, as a full document, as a hyper-texted document, as a linked-document, or the like, as referenced hereinabove. Thereby, the present invention may provide an asset bucket that allows for access to any and all agreements, past, present, and future, that are necessary to use a particular endorser as an endorser, including any required group license agreements (GLAs).

For example, any user seeking to utilize the names or likenesses of more than two MLB players in connection with a commercial product, product line or promotion may sign a GLA that includes the MLBPA. A properly executed and approved GLA may grant the use of the players' names and/or likenesses, but may not license the use of any MLB team logos or marks, for example. Examples of products that may be licensed by the MLBPA include trading cards, video games, T-shirts, caps, and a wide variety of other products such as pennants, posters, pins, action figures, and advertising campaigns for a wide variety of products and services.

By way of further example, a user may seek to have two talents from the same MLB team endorse an advertisement for a particular car dealer. The talent desired may be identified and the system may prompt the user to the need for a GLA that includes the MLBPA. The system may provide the user with a prior approved MLBPA GLA, and/or may provide access to GLAs previously used by or with the talent. The user may review, edit and send for further review, to each party to the GLA, a copy of the proposed agreement. Although a talent-specific GLA may not need to be, or as a practical matter, be, edited, a user may offer minor edits and may edit/fill-in a particular GLA to better fit the given situation. Agreement between the parties is reached when an approval is sent by each party into the system of the present invention. Approval by the MLBPA may include agreement with the licensing terms and endorsed creative, while an approval from a talent may include acknowledgment of MLBPA's agreement and an agreement with the content of the creative to be used as well of the attributes of the ad to be run. As one skilled in the art would understand, such approvals may be made piecemeal and may occur in any order. For example, if the talent agrees to the talent agreement such approval may be conditioned on the acceptance of the GLA by the MLBPA.

GLAs may also be utilized with other talents associated with particular industries that may have organized labor, such as other professional sports, t.v., film, music and literature. For example, an artist may have a contractual relationship with a music label that may limit the artist's endorsements without approval from the label. By way of further example, the band Foo Fighters are under the RCA label, and may thus need agreement from RCA to endorse a product during a concert. A user may select the Foo Fighters as a talent and may provide information regarding the product and creative to be used. A GLA may be recommended by the system to the user, which reflects terms that may be agreeable to both the Foo Fighters and RCA. The GLA may be recommended upon selection of the desired talent and prior to any review and/or approval by the parties.

Similarly, a whole associated collection of assets, such a sports team or cast of a t.v. show, for example, may utilize a GLA. By way of further example, the cast of the hit t.v. show may be recommended to endorse a particular creative, Although no commercial entity or organization may be a party to the contract, the individual actors may wish to execute a GLA to ensure that the terms applied to one are applied to all. In this way, an otherwise unorganized group of talent may independently, and/or uniquely of each other, review and approve a GLA to participate in the same endorsement. In this way, the system may facilitate greater opportunities to license groups of assets otherwise too impractical, both in time and money spent, to utilize as a endorser.

GLAs may also be utilized with assets and the multiple holders of those assets, such as, for example, museums and fine art collections generally. As discussed above, the holders, insurers and exhibitioners of certain art may be remote from each other and thus may not be easily contacted and/or negotiated with. The present invention may facilitate and ease the communication between the interested parties, and may also provide pre-approved GLAs. The system may also recommend, based on the user request, any necessary customs and other governmental approvals related to the moving and display of the art, Again, the present invention may provide enhanced efficiencies by more easily bringing disparate parties together in agreement through the use of the reques and approval processes described herein.

Thus, as would be evident to those possessing an ordinary skill in the pertinent arts, any myriad of formulations may be implemented to calculate the metrics of an asset. The system of the present invention may thus account for assets differently based on the underlying metric of the asset or previously achieved metrics of the asset.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A method for providing a group licensing agreement, comprising the steps of:
contacting, via a first communication network, at least two talents for an approval of at least one endorsement agreement with at least one requester;
receiving the approval from at least one of the talents;
storing a group license agreement for a group that includes the at least two talents, wherein a second approval of the group license agreement is necessary for execution of the endorsement agreement;
communicating a request for a second approval to the group including the at least two talents; and
receiving the second approval, and accordingly allowing the execution of the endorsement agreement.

2. The method of claim 1, wherein the endorsement agreement comprises an advertising agreement.

3. The method of claim 1, wherein the group license agreement is associated with at least one media asset.

4. The method of claim 3, wherein the at least one media asset comprises multimedia content related to the requester.
